(19) United States
(12) Patent Application Publication
(10) Pub. No.: US 2009/0276385 A1
(43) Pub. Date: Nov. 5, 2009

(54) Artificial-Neural-Networks Training Artificial-Neural-Networks

(76) Inventor: Stanley Hill, Holden, MA (US)

Correspondence Address: STANLEY K. HILL, 44 NOLA DRIVE, HOLDEN, MA, 01520, US

(21) Appl. No.: 12/431,589

(22) Filed: Apr. 28, 2009

Related U.S. Application Data
(60) Provisional application No. 61/048,963, filed on Apr. 30, 2008.

(51) Int. Cl. G06N 3/08

(52) U.S. Cl. 706/25

(57) ABSTRACT

A method of training an artificial-neural-network includes applying a training algorithm to a first artificial-neural-network using a first training set to generate a sequence of weight values associated with a connection in the first artificial-neural-network. The method also includes training a second artificial-neural-network to generate a weight value, where the training utilizes a second training set. The second training set includes the generated sequence of weight values associated with the connection in the first artificial-neural-network. A system includes a first artificial-neural-network including a plurality of connections, where each connection is associated with a weight value. The system also includes a second artificial-neural-network including a plurality of outputs, where each output generates the weight value associated with one connection of the plurality of connections in the first artificial-neural-network during a training of the first artificial-neural-network.

This application claims the benefit of U.S. Provisional Patent Application No. 61/048963 entitled “Artificial Neural Networks Training Artificial Neural Networks” and filed on Apr. 30, 2008, the subject matter of which is incorporated herein by reference.

### FIELD OF THE DISCLOSURE

The present disclosure generally relates to training artificial-neural-networks.

### BACKGROUND

Artificial intelligence includes the study and design of computer systems to exhibit information processing characteristics associated with intelligence, such as language comprehension, problem solving, pattern recognition, learning, and reasoning from incomplete or uncertain information. Many researchers attempt to achieve artificial intelligence by modeling computer systems after the human brain. This computer modeling approach to information processing based on the architecture of the brain is frequently referred to as connectionism. There are many kinds of connectionist computer models. These models are commonly referred to as connectionist networks or, more commonly, artificial-neural-networks. Artificial-neural-networks are enjoying use in an increasing variety of applications, especially applications in which there is no known mathematical algorithm for describing the problem being solved.

Artificial-neural-networks generally comprise four parts: nodes, activations, connections, and connection weights. Generally, a node is to an artificial-neural-network what neurons are to a biological neural-network. Artificial-neural-networks are typically composed of many nodes. There are two kinds of network connections in an artificial-neural-network: input connections and output connections. An input connection is a conduit through which a node receives information and an output connection is a conduit through which a node of an artificial-neural-network sends information. A connection can be both an input connection and an output connection. For example, when a connection is used to move information from a first node to a second node, the connection is an output connection to the first node and an input connection to the second node. Thus, the function of connections in artificial-neural-networks can be viewed as a conduit through which nodes receive input from other nodes and send output to other nodes.

### BRIEF DESCRIPTION OF THE DRAWINGS

In the following detailed description of preferred embodiments of the present invention, reference is made to the accompanying Figures, which form a part hereof, and in which are shown by way of illustration specific embodiments in which the present invention may be practiced. It should be understood that other embodiments may be utilized and changes may be made without departing from the scope of the present invention.

FIG. 1 is an illustration of a structure for a first artificial-neural-network;

FIG. 2 illustrates a set of weight values generated during the training of the first artificial-neural-network;

FIG. 3 illustrates a first subset of the weight values shown in FIG. 2 that may be used in a training set for a second artificial-neural-network;

FIG. 4 illustrates a second subset of the weight values shown in FIG. 2 that may be used in a training set for the second artificial-neural-network;

FIG. 5 illustrates a third subset of the weight values shown in FIG. 2 that may be used in a training set for the second artificial-neural-network;

FIG. 6 is an illustration of the structure of the second artificial-neural-network;

FIG. 7 is an illustration of a method for training the second artificial-neural-network to be used as a trainer artificial-neural-network;

FIG. 8 is a flow chart illustrating a method of training an artificial-neural-network to become a trainer artificial-neural-network;

FIG. 9 is an illustration of a method of using a trainer artificial-neural-network to train another artificial-neural-network;

FIG. 10 is a flow chart illustrating a method of using a trainer artificial-neural-network to train another artificial-neural-network; and

FIG. 11 depicts an illustrative embodiment of a general computer system.

### DETAILED DESCRIPTION

Systems and methods of training artificial-neural-networks are disclosed. In a first particular embodiment, a first method of training a second artificial-neural-network is disclosed. The first method includes applying a training algorithm to a first artificial-neural-network using a first training set to generate a sequence of weight values associated with a connection in the first artificial-neural-network. For example, training an artificial-neural-network using an iterative training algorithm, such as a backpropagation algorithm, generates a sequence of weight values associated with each connection in the artificial-neural-network being trained. The first method also includes training the second artificial-neural-network to generate a weight value, wherein the training utilizes a second training set that includes the generated sequence of weight values associated with the connection in the first artificial-neural-network. The second artificial-neural-network may be used as a trainer artificial-neural-network.

In a second particular embodiment, a second method of training an artificial-neural-network is disclosed. The second method includes training a first artificial-neural-network by using outputs generated by a second artificial-neural-network as weight values for connections in the first artificial-neural-network.

In a third particular embodiment, a system for training an artificial-neural-network is disclosed. The system includes a first artificial-neural-network including a plurality of connections. Each connection is associated with a weight value. The system also includes a second artificial-neural-network including a plurality of outputs. Each output generates the weight value associated with one connection of the plurality of connections in the first artificial-neural-network during a training of the first artificial-neural-network.

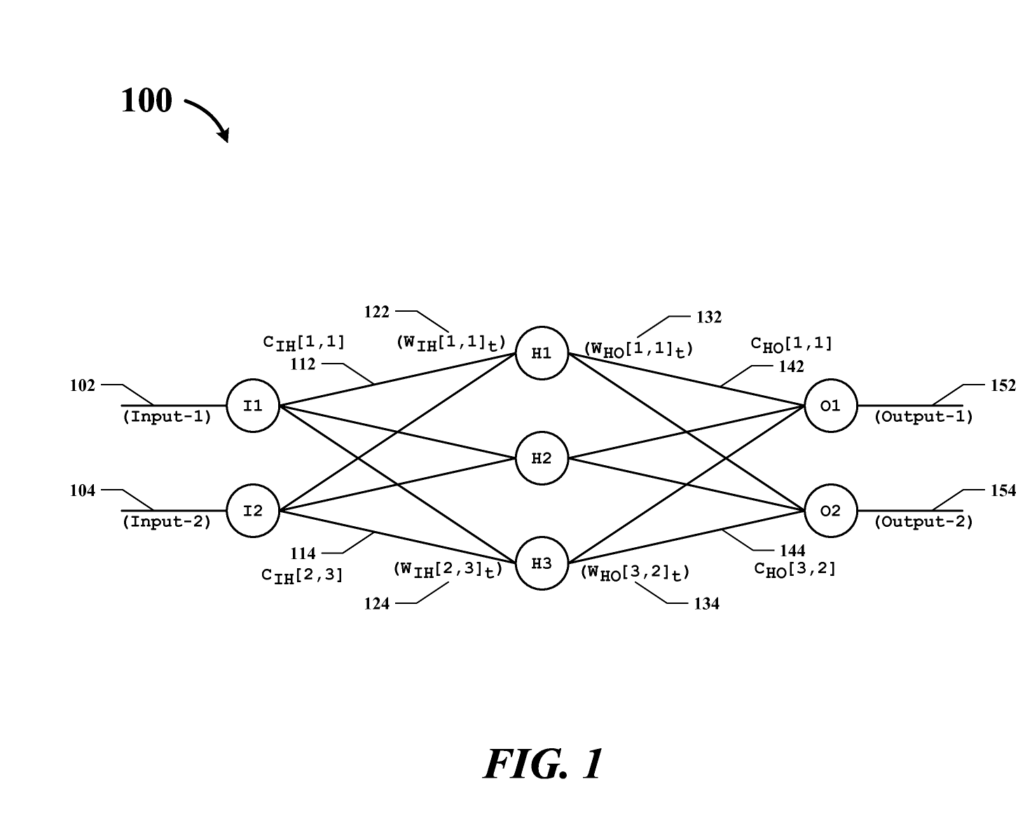

Referring to FIG. 1, a structure for an artificial-neural-network 100 is disclosed. The structure represents a 3-layered artificial-neural-network 100. The 3-layered artificial-neural-network 100 has three different layers of nodes: input nodes, hidden nodes, and output nodes. The artificial-neural-network 100 in FIG. 1 has two input nodes I1, I2 in its input layer, three hidden nodes H1, H2, H3 in its hidden layer, and two output nodes O1, O2 in its output layer. Each node in the artificial-neural-network 100 has associated with it a function that takes the input(s) to the node as arguments to the function and computes an output value for the node. These functions are sometimes referred to in the art as activation functions. In this artificial-neural-network 100, each input node in the input layer is connected to each hidden node in the hidden layer and each hidden node in the hidden layer is connected to each output node in the output layer. By way of example, connection 112 connects input node I1 to hidden node H1, connection 114 connects input node I2 to hidden node H3, connection 142 connects hidden node H1 to output node O1, and connection 144 connects hidden node H3 to output node O2.

The present disclosure primarily focuses on fully-connected artificial-neural-networks having three layers: an input layer, a hidden layer, and an output layer. Each node in the input layer is connected to each node in the hidden layer and each node in the hidden layer is connected to each node in the output layer. However, one of ordinary skill in the art will readily recognize that particular embodiments in accordance with inventive subject matter disclosed herein may include artificial-neural-networks having additional layers of nodes or include artificial-neural-networks that may not be fully connected. Additionally, particular embodiments in accordance with inventive subject matter disclosed herein may include artificial-neural-networks having many more nodes in any of their layers than are shown in examples described herein.

### Notation

{a|R(a)} refers to a set of all a such that the Relation R(a) is true. For example, {a₁, a₂, a₃, . . . , aₙ} represents the set {aₖ|1<=k<=n}.

C_{IH}[i,j] refers to a connection from the i^{th} node in the input layer (I) to the j^{th} node in the hidden layer (H). For example, C_{IH}[1,1] refers to the connection 112 in the artificial-neural-network 100 from I1 to H1 and C_{IH}[2,3] refers to the connection 114 from I2 to H3. C_{HO}[j,k] refers to the connection from the j^{th} node in the hidden layer (H) to the k^{th} node in the output layer (O). For example, C_{HO}_{[1,1}] refers to the connection 142 from H1 to O2 and C_{HO}[3,2] refers to connection 144 from H3 to O2.

W_{IH}[i,j] refers to the value of the weight associated with the connection C_{IH}[i,j] after iteration number t in a training algorithm has been performed. For example, W_{IH}[1,1]ₜ 122 refers to a value of the weight associated with the connection C_{IH}[1,1] 112 and W_{IH}[2,3]ₜ 124 refers to a value of the weight associated with the connection C_{IH}[2,3] 114. W_{HO}[1,1]ₜ 132 refers to a value of the weight associated with the connection C_{HO}[1,1] 142 and W_{HO}[3,2]ₜ 134 refers to a value of the weight associated with the connection C_{HO}[3,2] 144.

During operation, the artificial-neural-network 100 may be provided with a set of input values 102, 104, one input value for each input node in the artificial-neural-network 100. Each input node I1, I2 performs its activation function to generate an output value based on the input to the input node. The generated output value is associated with each connection from the input node to a node in the hidden layer. The output value associated with a connection may be multiplied by the weight value associated with the connection to generate an input value to a node in the hidden layer. For example, the output value computed by the activation function of I1 is associated with C_{IH}[1,1] 112 and may be multiplied by W_{IH}[1,1]ₜ 122 to generate an input to H1. Also, the output value computed by the activation function of 12 is associated with C_{IH}[2,3] 114 and may be multiplied by W_{IH}[2,3]ₜ 124 to generate an input to H3.

Similarly, each hidden node H1, H2, H3 performs its activation function to generate an output value based on the input(s) to the hidden node. The generated output value is associated with each connection from the hidden node to a node in the output layer. The output value associated with a connection may be multiplied by the weight value associated with the connection to generate an input value to a node in the output layer. For example, the output value computed by the activation function of H1 is associated with C_{HO}[1,1] 142 and may be multiplied by W_{HO}[1,1]ₜ 132 to generate an input to O1. Also, the output value computed by the activation function of H3 is associated with C_{HO}[3,2] 144 and may be multiplied by W_{HO}[3,2]ₜ 134 to generate an input to O2.

Each output node O1, O2 performs its activation function to generate an output value based on the input(s) to the output node. The output nodes O1, O2 do not have connections to other nodes in the artificial-neural-network 100 so the outputs computed by the output nodes O1, O2 become the outputs of the artificial-neural-network 100.

When an artificial-neural-network operates in the above-described manner, it is sometimes referred to in the art as operating in a feed-forward manner. Artificial-neural-networks commonly operate in a feed-forward manner once they have been trained. Operating in a feed-forward manner can generally be performed efficiently and may be very fast. Unless herein stated otherwise, operating an artificial-neural-network in a feed-forward manner includes electronically computing output values for nodes in the artificial-neural-network. For example, an artificial-neural-network may be implemented in computer software and the computer software may be executed on a general purpose computer to electronically compute the output values for nodes in the artificial-neural-network. Also, an artificial-neural-network may be at least partially implemented in electronic hardware such that the output values for nodes in the artificial-neural-network are electronically computed at least in part by the electronic hardware.

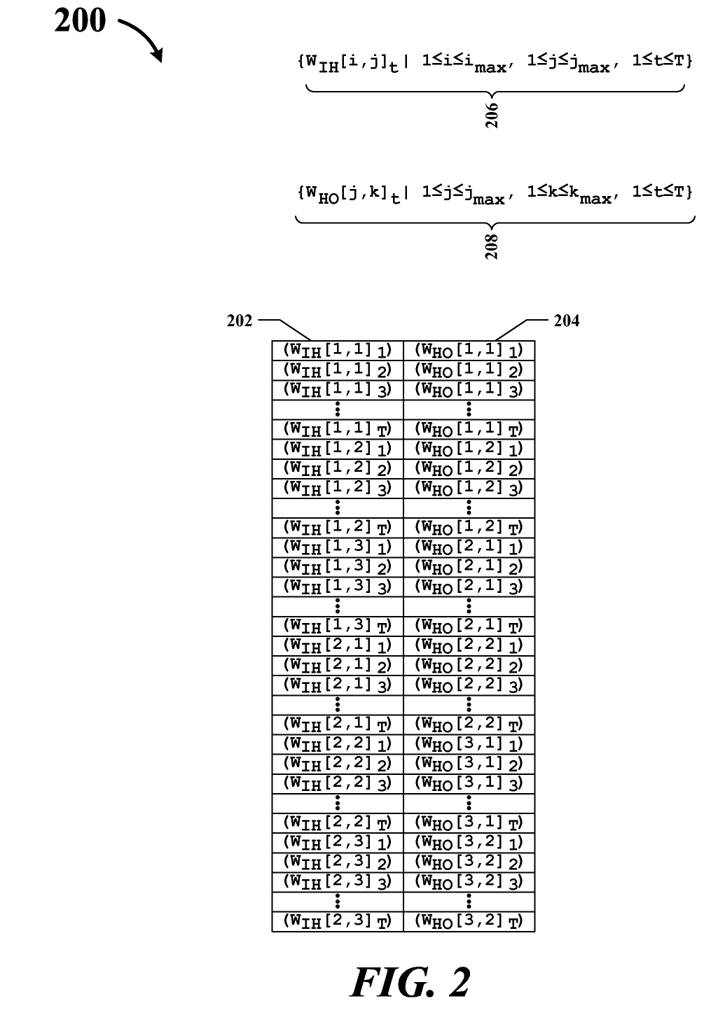

Referring to FIG. 2, a set of weight values 200 generated during the training of the artificial-neural-network 100 is disclosed. Training an artificial-neural-network comprises applying a training algorithm, sometimes referred to as a “learning” algorithm, to an artificial-neural-network in view of a training set. A training set may include one or more sets of inputs and one or more sets of outputs with each set of inputs corresponding to a set of outputs. A set of outputs in a training set comprises a set of outputs that are desired for the artificial-neural-network to generate when the corresponding set of inputs is inputted to the artificial-neural-network and the artificial-neural-network is then operated in a feed-forward manner.

Training an artificial-neural-network involves computing the weight values associated with the connections in the artificial-neural-network. Training an artificial-neural-network, unless herein stated otherwise, includes electronically computing weight values for the connections in the artificial-neural-network. Similarly, applying a training algorithm to an artificial-neural-network, unless herein stated otherwise, includes electronically computing weight values for the connections in the artificial-neural-network.

In a particular embodiment, a training algorithm is applied to the artificial-neural-network 100 to generate the set of weight values 200. The training algorithm may be an iterative training algorithm, such as a backpropagation algorithm. In a particular embodiment, a weight value is computed for each connection during each iteration of the training algorithm. For example, W_{IH}[1,1]₁ is generated for connection C_{IH}[1,1] 112 during the first iteration of the training algorithm and W_{HO}[1,1]₁ is generated for connection C_{HO}[1,1] 142 during the first iteration of the training algorithm. The total number of iterations of the training algorithm is referred to herein as T. Thus, W_{IH}[1,1]_{T} is generated for connection C_{IH}[1,1] 112 during the T^{th} (i.e., last) iteration of the training algorithm. In this manner, a sequence of weight values may be generated for each connection in the artificial-neural-network 100. The set of weight values generated during the T^{th} iteration of the training algorithm represent the trained artificial-neural-network and are then used when operating the trained artificial-neural-network in a feed-forward manner. The first column 202 in FIG. 2 shows the weight values generated during training for the connections between the input nodes I1, I2 and the hidden nodes H1, H2, H3 and the second column 204 shows the weight values generated for the connections between the hidden nodes H1, H2, H3 and the output nodes O1, O2. The weight values in the first column 202 may be expressed by the set expression 206 and the weight values in the second column 204 may be express by the set expression 208.

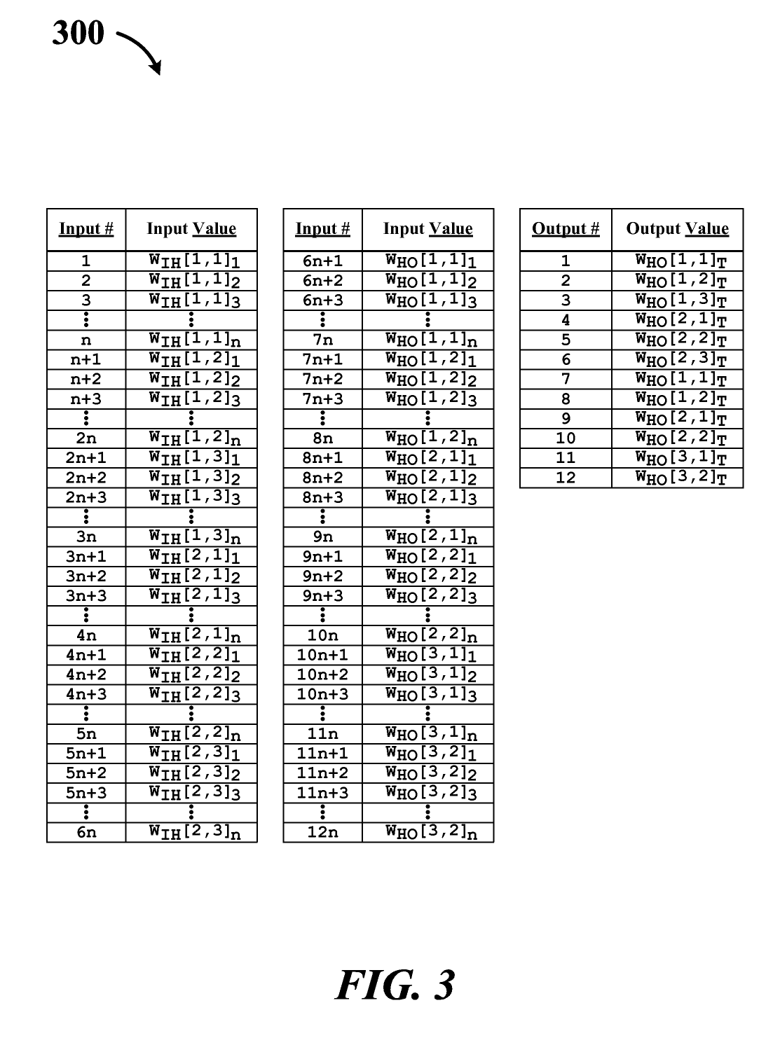

Referring to FIG. 3, a first subset of the weight values shown in FIG. 2 that may be used in a training set for a trainer artificial-neural-network is disclosed. The phrase “trainer artificial-neural-network” is used herein to refer to an artificial-neural-network that can generate output values to be used as weight values in another artificial-neural-network. The first subset of the weight values includes the first n weight values of FIG. 2 associated with each connection of the artificial-neural-network 100 and the final (i.e., the T^{th}) weight value associated with each connection of the artificial-neural-network 100. The value of n to be used in a particular embodiment can be determined without undue experimentation. A higher value of n will generally require more computing power and/or time to perform some of the methods disclosed herein. However, a higher value of n may result in greater accuracy of artificial-neural-networks generated in accordance with inventive subject matter disclosed herein. Additionally, a higher value of n may result in a more efficient overall process of training an artificial-neural-network in particular embodiments. In particular embodiments, the value of n is greater than or equal to 3.

The final weight value (i.e., the T^{th} value) in each sequence of weight values associated with a connection of the artificial-neural-network 100 is mapped to an output of the trainer artificial-neural-network. The artificial-neural-network 100 should perform best when operated in a feed-forward manner when the weight values for each connection are set to the final weight value of the sequence of weight values generated for that connection during the training of the artificial-neural-network 100. A goal of training the trainer artificial-neural-network is to enable the trainer artificial-neural-network, once trained, to generate weight values that improve the performance of the artificial-neural-network 100.

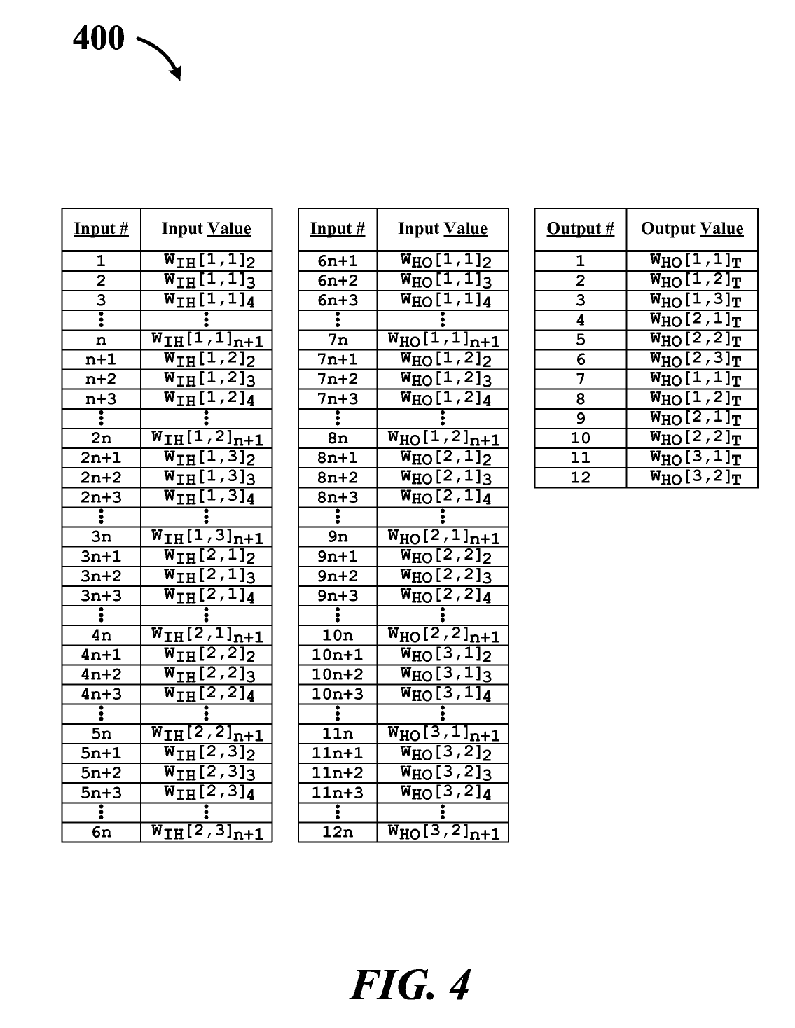

Referring to FIG. 4, a second subset of the weight values shown in FIG. 2 that may be used in a training set for a trainer artificial-neural-network is disclosed. The second subset of the weight values includes n weight values of FIG. 2 associated with each connection of the artificial-neural-network 100 and the final (i.e., the T^{th}) weight value associated with each connection of the artificial-neural-network 100. The n weight values start with the 2^{nd} weight value in each sequence of weight values associated with a connection in the artificial-neural-network 100 and end with the (n+1)^{st} weight value in each sequence of weight values associated with a connection in the artificial-neural-network 100. The final weight value in each sequence of weight values associated with a connection of the artificial-neural-network 100 is mapped to the same output of the second artificial-neural-network as in FIG. 3. For example, W_{HO}[1,1]_{T} is mapped to output #1 in both FIG. 3 and FIG. 4. Thus, a goal of training the trainer artificial-neural-network is to enable the trainer artificial-neural-network, once trained, to generate a weight value for output #1 that can be used for connection C_{HO}[1,1] 112 in the artificial-neural-network 100.

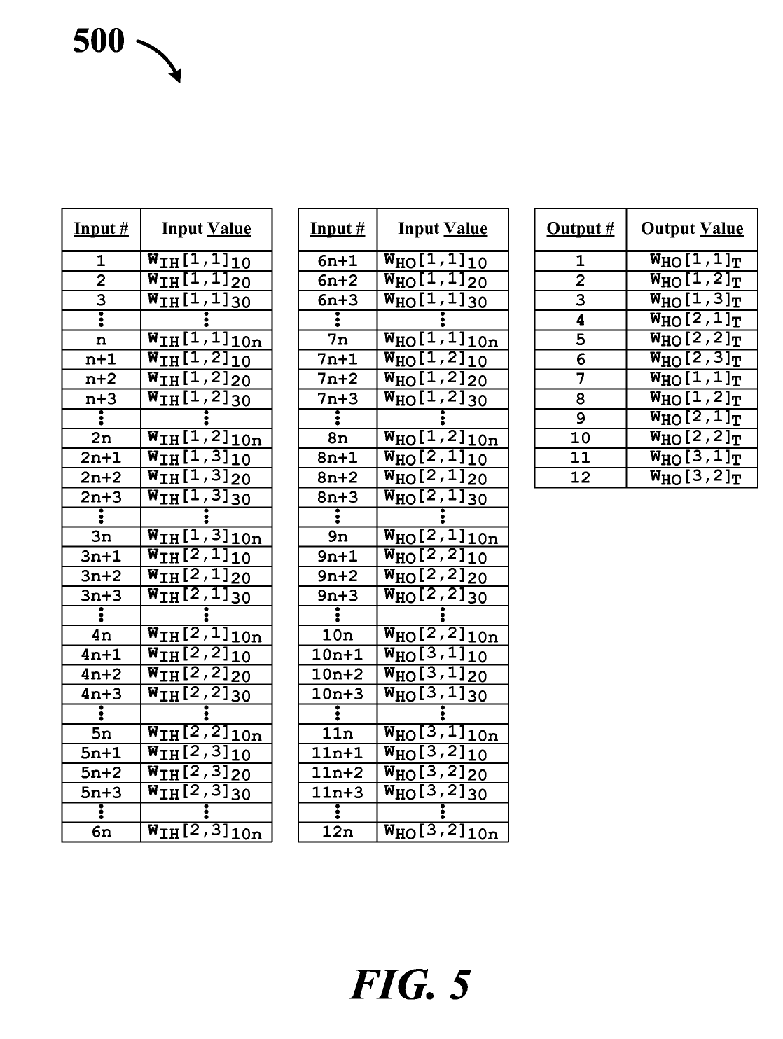

Referring to FIG. 5, a third subset of the weight values shown in FIG. 2 that may be used in a training set for a trainer artificial-neural-network is disclosed. The third subset of the weight values includes n weight values of FIG. 2 associated with each connection of the artificial-neural-network 100 and the final (i.e., the T^{th}) weight value associated with each connection of the artificial-neural-network 100. The n weight values start with the 10^{th} weight value in each sequence of weight values associated with a connection in the artificial-neural-network 100 and include every 10^{th} weight value in each sequence up to the (10n)^{th} weight value in each sequence of weight values associated with a connection in the artificial-neural-network 100. The final weight value in each sequence of weight values associated with a connection of the artificial-neural-network 100 is mapped to the same output of the trainer artificial-neural-network as in FIGS. 3 and 4. For example, W_{HO}[1,1]_{T} is mapped to output #1 in FIG. 3, FIG. 4, and FIG. 5.

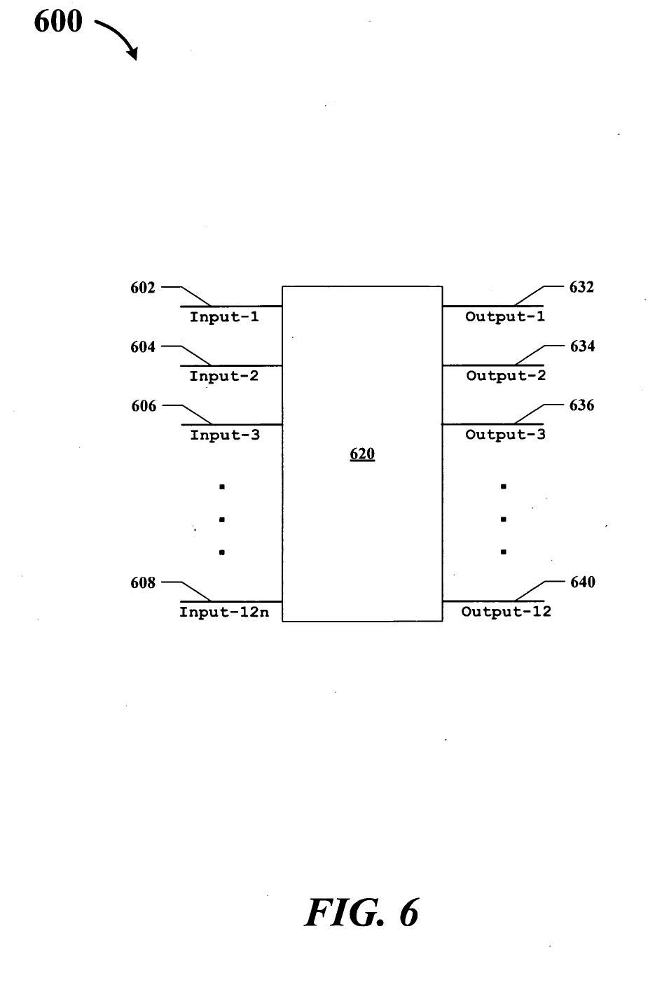

Referring to FIG. 6, an illustration of the structure 600 of the trainer artificial-neural-network is disclosed. The inputs and outputs of the trainer artificial-neural-network correspond to the inputs and outputs of FIGS. 3, 4, and 5. For example, Input-1 602 corresponds to Input #1 of FIGS. 3, 4, and 5, Input-2 604 corresponds to Input #2, Input-3 606 corresponds to Input #3, and Input-12n 608 corresponds to Input #12n. Also, Output-1 632 corresponds to Output #1, Output-2 634 corresponds to Output #2, Output-3 636 corresponds to Output #3, and Output-12 638 corresponds to Output #12. Accordingly, the trainer artificial-neural-network includes 12n inputs and 12 outputs.

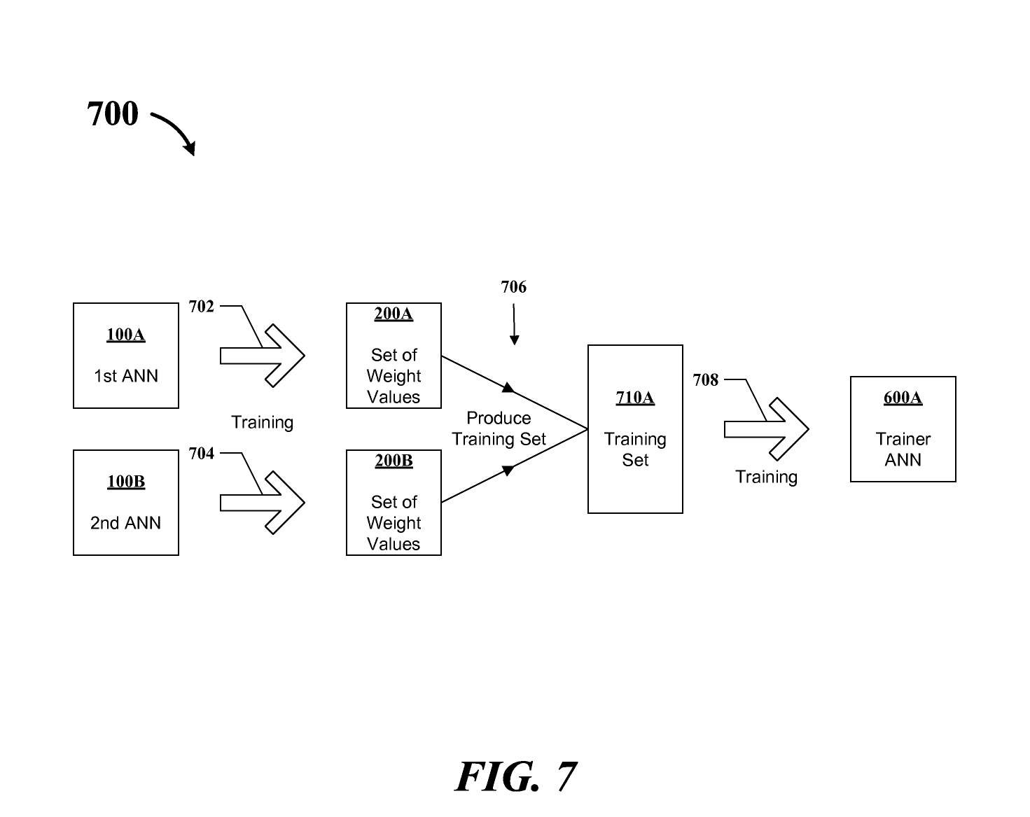

Referring to FIG. 7, an illustration 700 of a method for training a trainer artificial-neural-network 600A is disclosed. At 702, a training algorithm, such as a backpropagation algorithm, is applied to a first artificial-neural-network 100A (1^{st} ANN) having the same structure as the artificial-neural-network 100 of FIG. 1 to generate a set of weight values 200A such as the set of weight values 200 shown in FIG. 2. At 704, the same training algorithm is also applied to a second artificial-neural-network 100B (2^{nd} ANN) having the same structure as the artificial-neural-network 100 of FIG. 1 to generate a set of weight values 200B such as the set of weight values 200 shown in FIG. 2. In particular embodiments, only one artificial-neural-network is trained to generate a single set of weight values. In other particular embodiments, more than two artificial-neural-networks are trained to generate more than two sets of weight values.

The two artificial-neural-networks 100A, 100B are trained using two different training sets. In particular embodiments, the two artificial-neural-networks 100A, 100B are both trained to work on similar pattern recognition problems. For example, both artificial-neural-networks 100A, 100B may be trained to work on image recognition problems. However, the first artificial-neural-network 100A may be trained to recognize a particular image, such as an image of a particular face or an image of a particular military target, for example, and the second artificial-neural-network 100B may be trained to recognize a different particular image, such as an image of a different particular face or an image of a different particular military target. Similarly, both artificial-neural-networks 100A, 100B may be trained to recognize voice patterns while each artificial-neural-network is trained to recognize a different voice pattern.

At 706, the two sets of weight values 200A, 200B are used to generate a training set 300A for the trainer artificial-neural-network 600A. The training set may include subsets of the sets of weight values 200A, 200B, such as the subsets of weight values shown in FIGS. 3, 4, and 5, for example. At 706, the trainer artificial-neural-network 600A is trained using the training set 300A. The training algorithm used to train the trainer artificial-neural-network 600A may be the same training algorithm used to train the first artificial-neural-network 100A and the second artificial-neural-network 100B or it may be a different training algorithm.

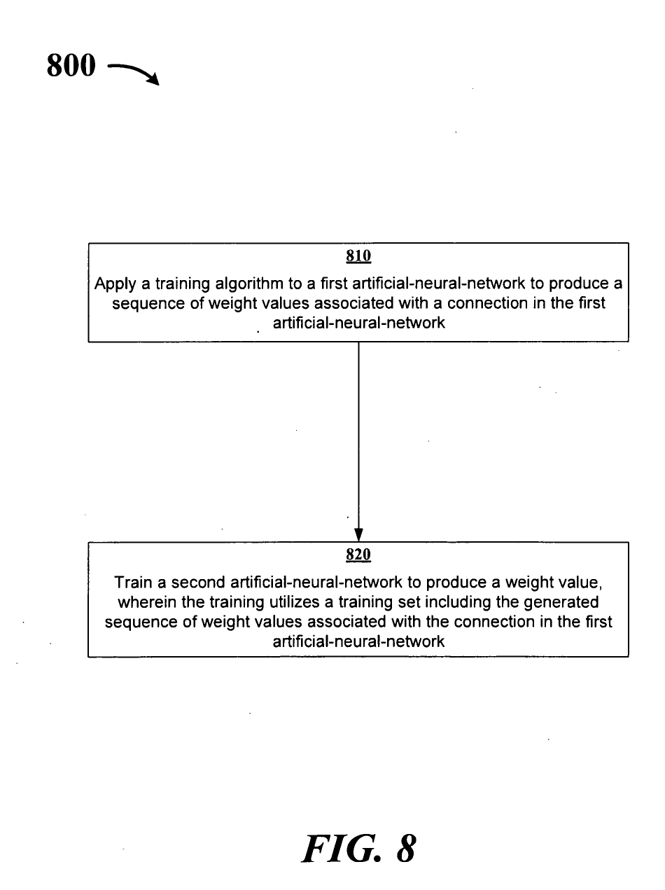

Referring to FIG. 8, a flow chart illustrating a method of training an artificial-neural-network to become a trainer artificial-neural-network is disclosed. The method includes applying a training algorithm to a first artificial-neural-network, at 810. The application of the training algorithm to the first artificial-neural-network generates a sequence of weight values associated with a connection in the first artificial-neural-network. At 820, a second artificial-neural-network is trained to generate a weight value. The training of the second artificial-neural-network utilizes a training set that includes the generated sequence of weight values associated with the connection in the first artificial-neural-network.

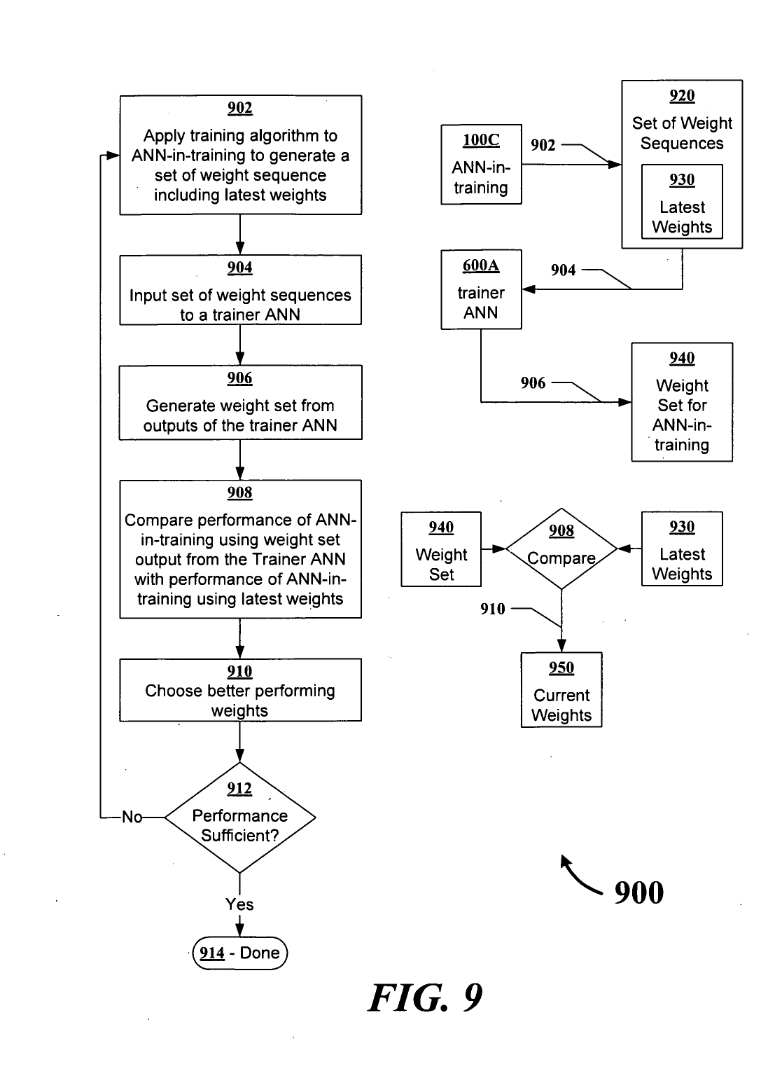

Referring to FIG. 9, an illustration 900 of a method of using a trainer artificial-neural-network to train another artificial-neural-network is disclosed. At 902, a training algorithm is applied to an artificial-neural-network to generate a set of sequences of weight values. Each sequence of weight values corresponds to a connection in the artificial-neural-network. The training algorithm can be an iterative algorithm, such as a backpropagation algorithm, for example. The artificial-neural-network to which the training algorithm may be referred to herein as an ANN-in-training. The training algorithm may be applied for a particular number n of iterations to generate a sequence of n weight values for each connection in the ANN-in-training. For example, in a particular embodiment the number n of iterations will be equal to 3 and will generate a sequence of 3 weight values for each connection in the ANN-in-training. In another particular embodiment, the number n of iterations will be equal to 10 and will generate a sequence of 10 weight values for each connection in the ANN-in-training. The set of weight values comprising the most recent weight value generated for each connection may be referred to herein as the latest weights or the latest weight values. The illustration 900 shows an example of applying a training algorithm to an ANN-in-training 100C to generate a set 290 of sequences of weight values that include the latest weight values 930 for each connection in the ANN-in-training 100C. For example, the ANN-in-training 100C may have the same structure as the 1^{st} ANN 100A and the 2^{nd} ANN shown in FIG. 7.

At 904, the generated set of sequences of weight values is input into a trainer artificial-neural-network (“ANN”). Each weight value becomes the input value for an input of the trainer ANN. In particular embodiments, each connection in the ANN-in-training corresponds to a particular number n of inputs of the trainer ANN and the generated sequence of weight values of each connection in the ANN-in-training is input to the particular number n of inputs. Thus, each particular number n of inputs of the trainer ANN may correspond to a connection in the ANN-in-training and may be configure to receive the generated sequence of weight values associated with the connection. The illustration 900 shows the set 920 of weight sequences being input into the trainer ANN 600A. In particular embodiments, the trainer ANN 600A will have been trained in accordance with the method disclosed in FIG. 7.

At 906, the trainer ANN is operated in a feed forward manner to generate a set of one or more weight values for the ANN-in-training. Each weight value is generated by an output of the trainer ANN. In particular embodiments, each output of the trainer ANN corresponds to a particular connection in the ANN-in-training and generates a weight value corresponding to the particular connection in the ANN-in-training. The illustration 900 shows the trainer ANN 600A producing a weight set 940 for the ANN-in-training.

At 908, the performance of the ANN-in-training using the set of weight values output from the trainer ANN is compared with the performance of the ANN-in-training using the latest weight values generated by the training algorithm for each connection in the ANN-in-training. The illustration 900 shows the performance of the ANN-in-training using the set of weight values 940 being compared 908 with the performance of the ANN-in-training using the latest weight values 930.

At 910, the better performing set of weight values is chosen as the current weight values 950 to be used in the ANN-in-training. At 912, it is determined whether the performance of the ANN-in-training is sufficient. If the performance of the ANN-in-training is sufficient then the method ends at 914. If the performance of the ANN-in-training is not sufficient, then the method returns to 902 and the training algorithm is applied again.

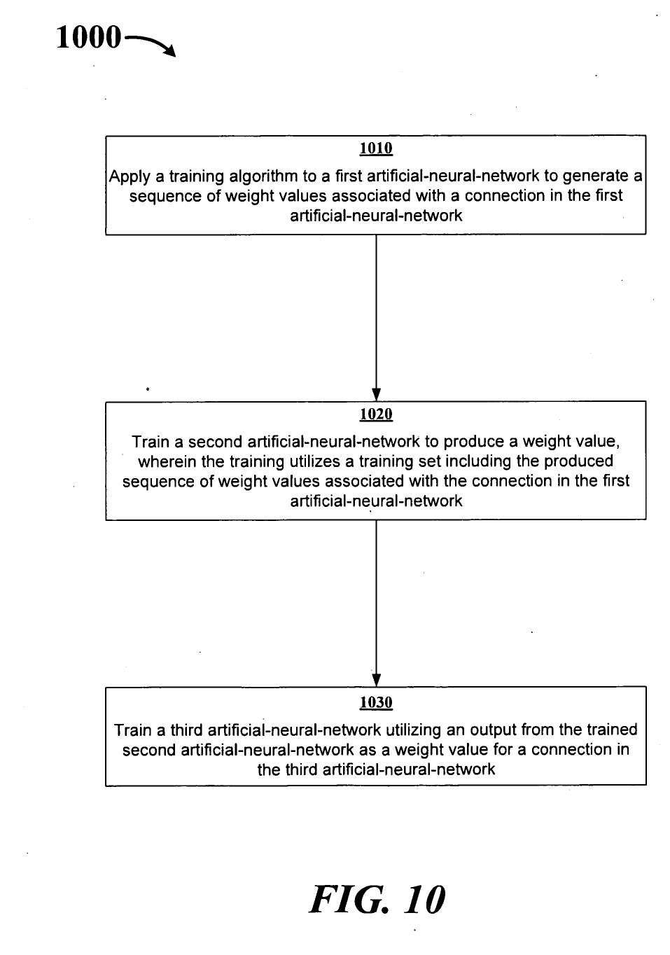

Referring to FIG. 10, a flow chart illustrating a method of using a trainer artificial-neural-network to train another artificial-neural-network is disclosed. At 1010, a training algorithm is applied to a first artificial-neural-network to generate a sequence of weight values associated with a connection in the first artificial-neural-network. At 1020, a second artificial-neural-network is trained to generate a weight value. The training of the second artificial-neural-network utilizes a training set that includes the generated sequence of weight values associated with the connection in the first artificial-neural-network. At 1030, a third artificial-neural-network is trained utilizing an output from the trained second artificial-neural-network as a weight value for a connection in the third artificial-neural-network.

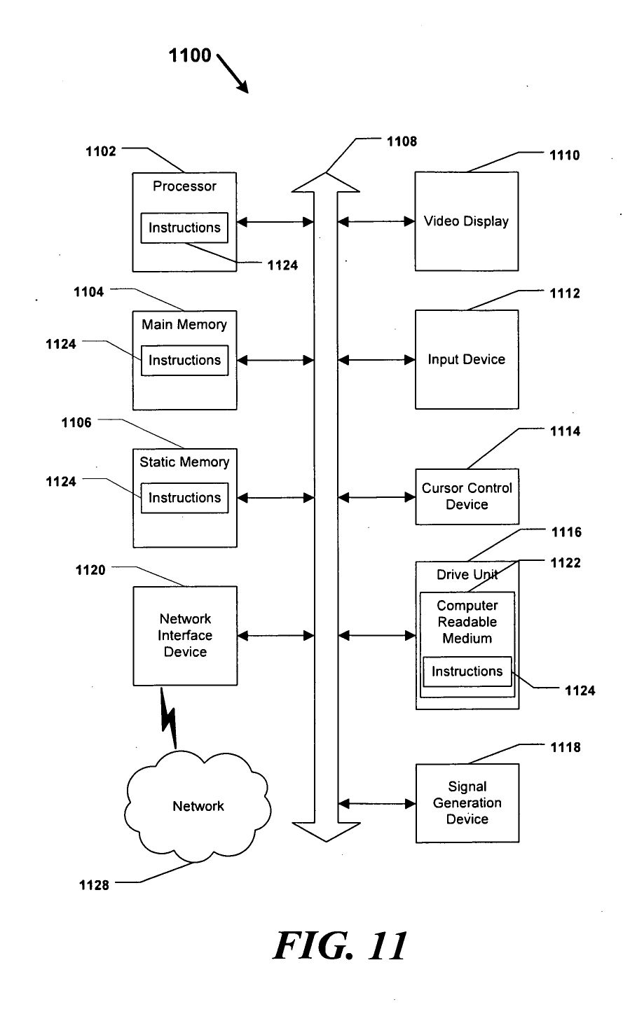

Referring to FIG. 11, an illustrative embodiment of a general computer system is shown and is designated 1100. The computer system 1100 can include a set of instructions 1124 that can be executed to cause the computer system 1100 to perform any one or more of the methods or computer-based functions disclosed herein. For example, the computer system 1100 may include instructions that are executable to perform the methods discussed with respect to FIGS. 7-10. In particular embodiments, the computer system 1100 may include instructions to implement the application of a training algorithm to train an artificial-neural-network or implement operating an artificial-neural-network in a feed-forward manner. In particular embodiments, the computer system 1100 may operate in conjunction with other hardware that is designed to perform methods discussed with respect to FIGS. 7-10. The computer system 1100 may be connected to other computer systems or peripheral devices via a network. Additionally, the computer system 1100 may include or be included within other computing devices.

As illustrated in FIG. 11, the computer system 1100 may include a processor 1102, e.g., a central processing unit (CPU), a graphics processing unit (GPU), or both. Moreover, the computer system 1100 can include a main memory 1104 and a static memory 1106 that can communicate with each other via a bus 1108. As shown, the computer system 1100 may further include a video display unit 1110, such as a liquid crystal display (LCD), a projection television display, a flat panel display, a plasma display, or a solid state display. Additionally, the computer system 1100 may include an input device 1112, such as a remote control device having a wireless keypad, a keyboard, a microphone coupled to a speech recognition engine, a camera such as a video camera or still camera, or a cursor control device 1114, such as a mouse device. The computer system 1100 can also include a disk drive unit 1116, a signal generation device 1118, such as a speaker, and a network interface device 1120. The network interface 1120 enables the computer system 1100 to communicate with other systems via a network 1126.

In a particular embodiment, as depicted in FIG. 11, the disk drive unit 1116 may include a computer-readable medium 1122 in which one or more sets of instructions 1124, e.g. software, can be embedded. For example, instructions for applying a training algorithm to an artificial-neural-network or instructions for operating an artificial-neural-network in a feed-forward manner can be embedded in the computer-readable medium 1122. Further, the instructions 1124 may embody one or more of the methods, such as the methods disclosed with respect to FIGS. 7-10, or logic as described herein. In a particular embodiment, the instructions 1124 may reside completely, or at least partially, within the main memory 1104, the static memory 1106, and/or within the processor 1102 during execution by the computer system 1100. The main memory 1104 and the processor 1102 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations, or combinations thereof.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing or encoding a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any one or more of a computer-readable medium or other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

While the present invention has been described in detail with respect to specific embodiments thereof, it will be appreciated that those skilled in the art, upon attaining an understanding of the foregoing, may readily conceive of alterations to, variations of and equivalents to these embodiments. Accordingly, the scope of the present invention should be assessed as that of the appended claims and by equivalents thereto.

What is claimed is:

1. A method comprising:
applying a training algorithm to a first artificial-neural-network using a first training set to generate a sequence of weight values associated with a connection in the first artificial-neural-network; and
training a second artificial-neural-network to generate a weight value, wherein the training utilizes a second training set including the generated sequence of weight values associated with the connection in the first artificial-neural-network.

2. The method of claim 1, wherein the applying a training algorithm comprises:
applying a backpropagation algorithm.

3. The method of claim 1, further comprising:
generating a plurality of sequences of weight values, wherein each sequence of the plurality of sequences of weight values is associated with a connection in the first artificial-neural-network; and
training the second artificial-neural-network to generate a plurality of output values, wherein each output value corresponds to a weight value associated with a connection in the first artificial-neural-network.

4. The method of claim 1, further comprising:
applying a training algorithm to a third artificial-neural-network using a third training set to produce a sequence of weight values associated with a connection in the third artificial-neural-network, wherein the second training set includes the produced sequence of weight values associated with the connection in the third artificial-neural-network.

5. A method comprising:
training a first artificial-neural-network by using outputs generated by a second artificial-neural-network as weight values for connections in the first artificial-neural-network.

6. The method of claim 5, further comprising:
applying a training algorithm to the first artificial-neural-network to generate a plurality of sequences of weight values associated with each of the connection in the first artificial-neural-network; and
inputting the plurality of generated sequences of weight values associated with the connections in the first artificial-neural-network into the second artificial-neural-network to generate the outputs used as weight values for the connections in the first artificial-neural-network.

7. A system comprising:
a first artificial-neural-network including a plurality of connections, wherein each connection is associated with a weight value; and
a second artificial-neural-network including a plurality of outputs, wherein each output generates the weight value associated with one connection of the plurality of connections in the first artificial-neural-network during a training of the first artificial-neural-network.

8. The system according to claim 7, wherein the second artificial-neural-network comprises:
a plurality of inputs, wherein each connection in the plurality of connections in the first artificial-neural-network corresponds to a particular number of the plurality of inputs of the second artificial-neural-network.

9. The system according to claim 8, wherein each particular number of the plurality of inputs of the second artificial-neural-network corresponding to a connection in the first artificial-neural-network is configured to receive a sequence of weight values associated with the connection in the first artificial-neural-network.
